(19) United States
(12) Patent Application Publication
(10) Pub. No.: US 2020/0064816 A1
(43) Pub. Date: Feb. 27, 2020

(54) CONTROL DEVICE, HOUSEHOLD APPLIANCE, AND PROGRAM

(71) Applicant: PANASONIC INTELLECTUAL PROPERTY MANAGEMENT CO., LTD., Osaka (JP)

(72) Inventors: Kenji YASU, Osaka (JP); Yoichi MASUDA, Osaka (JP)

(21) Appl. No.: 16/489,225

(22) PCT Filed: Feb. 19, 2018
(86) PCT No.: PCT/JP2018/005771

§ 371 Date: Aug. 27, 2019

(30) Foreign Application Priority Data
Feb. 28, 2017 (JP) 2017-035941

(51) Int. Cl. G05B 19/4155; H04L 29/06; H04W 76/30; H04W 12/00; H04W 24/08; H04W 76/19

(52) U.S. Cl. CPC G05B 19/4155; H04L 63/1458; H04W 76/30; H04W 88/02; H04W 24/08; H04W 76/19; G05B 2219/23238; H04W 12/00505

(57) ABSTRACT

A control device is a control device in a control system in which the control device connected via a network to a server in which an appliance and a user's smartphone assigned to control the appliance are stored in association with each other receives an instruction from the user's smartphone and controls an operating condition of an appliance. The control device determines whether a signal received from a different terminal satisfies a predetermined criterion. If the control device determines that the signal satisfies the predetermined criterion, the control device cuts off all communications via the network.

### TECHNICAL FIELD

The present invention relates to a control device, a household appliance, and a program.

### BACKGROUND ART

The Internet of Things (IoT) has been attracting great attention around the world in recent years. The connecting of various appliances to the Internet at all times is becoming a common practice (see Patent Literature 1). For example, settings such as ON/OFF of an air conditioner inside a house can be performed by a smartphone outside the house. Use of the IFTTT (If This Then That) service or the like makes it possible to set a linked operation, such as “if the room is light at sunny daytime, turn off the electric light,” by associating operating instructions for the sensor and the appliance together through a simple setting operation.

### CITATION LIST

### Patent Literature

Patent Literature 1: Japanese Unexamined Patent Application Publication No. 2013-152584

### SUMMARY OF INVENTION

The use of the IFTTT service or the like, however, raises a concern about security risk because part of the function of an appliance inside a house has to be opened to the public so as to be manipulated from the outside through the Internet. For example, in a case where appliances, a broadband router, and the like in the house are incorrectly set up, a problem is that they become targets of attack from an external third party, and face a high risk of being controlled illegitimately or receiving a DoS attack.

The present invention has been made in view of such conventional problems. It is an object of the present invention to provide a control device, a household appliance, and programs which are capable of reducing security risk.

For the purpose of solving the above problem, a control device according to an aspect of the present invention is the control device in a control system in which the control device connected via a network to a server in which a household appliance and a mobile terminal assigned to control the household appliance are stored in association with each other receives an instruction from the mobile terminal and controls an operating condition of the household appliance. The control device determines whether a signal received from a different terminal satisfies a predetermined criterion. If the control device determines that the signal satisfies the predetermined criterion, the control device cuts off all communications via the network.

In addition, a household appliance according to an aspect of the present invention is the household appliance in a control system in which the control device connected via a network to a server in which a household appliance and a mobile terminal assigned to control the household appliance are stored in association with each other receives an instruction from the mobile terminal and controls an operating condition of the household appliance. The household appliance determines whether a signal received from a different terminal satisfies a predetermined criterion. If the household appliance determines that the signal satisfies the predetermined criterion, the household appliance cuts off all communications via the network.

Furthermore, a program according to an aspect of the present invention is a program which causes a computer to function as the control device.

Moreover, a program according to an aspect of the present invention is a program which causes a computer to function as the household appliance.

The present invention can provide the control device, the household appliance and the programs which are capable of reducing the security risk.

### BRIEF DESCRIPTION OF DRAWINGS

FIG. 1 is a network configuration diagram of a control system according to embodiments.

FIG. 2 is a function block diagram of a control device according to an embodiment.

FIG. 3 is a sequence diagram of the control system according to the embodiment.

FIG. 4 is another sequence diagram of the control system according to the embodiment.

FIG. 5 is yet another sequence diagram of the control system according to the embodiment.

FIG. 6 is a flowchart of the control system according to the embodiment.

FIG. 7 is another flowchart of the control system according to the embodiment.

FIG. 8 is yet another flowchart of the control system according to the embodiment.

FIG. 9 is a function block diagram of an appliance according to another embodiment.

FIG. 10 is a sequence diagram of the control system according to the embodiment.

FIG. 11 is another sequence diagram of the control system according to the embodiment.

FIG. 12 is yet another sequence diagram of the control system according to the embodiment.

### DESCRIPTION OF EMBODIMENTS

Next, referring to the drawings, descriptions will be provided for a control system according to embodiments of the present invention. In the following drawings, the same or similar components are denoted by the same or similar reference signs.

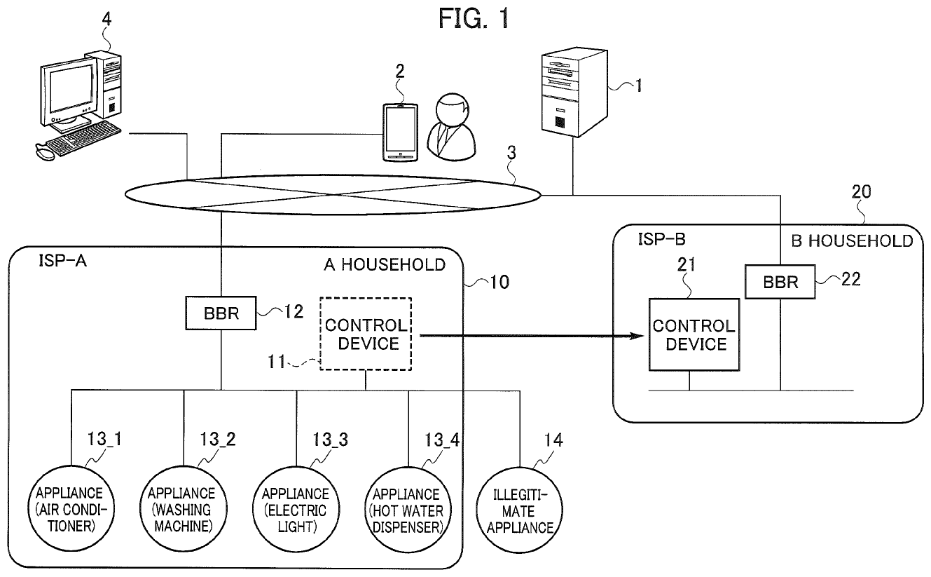

FIG. 1 is a network configuration diagram of the control system according to the embodiments. As illustrated in this drawing, a server 1, an A household 10, a B household 20 and the like are connected to a network 3, such as the Internet. In the A household 10, a control device 11 and a group of appliances 13_1, 13_2, 13_3, 13_4 are set up, and are connected via a BBR (broadband router) 12. In the B household 20, similarly, a BBR 22 and the like are set up. In the following descriptions, the appliances 13_1, 13_2, 13_3, 13_4 each will be simply referred to as an “appliance 13” or a “household appliance” on a case-by-case basis.

The server 1 is a management device which manages various data. For example, the server 1 stores (registers) the household appliances and a user's smartphone 2 capable of controlling the household appliances in association with the user's smartphone 2.

Specifically, the server 1 stores information on the appliances 13, information on the control device 11, and information on the user's smartphone 2 in association with the user, and provides the user with a function which allows the user to check how each appliance 13, the control device 11 and the like are connected together. In addition, depending on a registration request received from the control device 11, the server 1 registers various pieces of information. Furthermore, upon receipt of a connection configuration change notice, if information on an ISP (Internet service provider) indicated by the connection configuration change notice is different from the registered information, the server 1 informs the user's smartphone 2 of the difference. For example, in a case where the Internet service provider is changed from an ISP-A to an ISP-B, the server 1 informs the user's smartphone 2, owned by the user, of the change.

The user's smartphone 2 is a mobile terminal registered in the server 1. In the embodiments, the user's smartphone 2 is a mobile terminal owned by a user living in the A household 10. While out of the house, the user living in the A household 10 can do things such as setting on and off each appliance 13 in the house by manipulating the user's smartphone 2.

The control device 11 is a home server, such as the AiSEG (the registered trademark). For example, upon receipt of an instruction from the user's smartphone 2, the control device 11 controls the operating condition of each appliance 13. It is a matter of course that the control device 11 can control the appliance 13 based on the manipulation on the screen of the control device 11.

Each appliance 13 is a household appliance set in the A household 10. For example, the appliances 13_1, 13_2, 13_3, 13_4 are an air conditioner, a washing machine, an electric light, and a hot water dispenser, respectively. For its linkage with the IFTTT and the like as well as its control through the smartphone, the I/F for each appliance 13 opens to the outside. This raises a security risk concern that the appliance 13 is attacked directly from the outside, but not through the control device 11.

For example, there is a risk that an attacker 4, who is not registered in the server 1, continuously transmits ON/OFF control signals to the appliances 13. Otherwise, there is a risk that an illegitimate appliance (malware-infecting appliance) 14 is introduced into the A household 10 and transmits a large amount of control messages to the appliances 13. Furthermore, there is a risk that in a case where the software installed in the appliances 13 has not been updated for a long time, the appliances 13 remain vulnerable. There is, of course, a risk that the control device 11 and the appliances 13 are stolen (FIG. 1 illustrates a case where the control device 11 is stolen from the A household 10 and is set in the B household 20).

With these taken into consideration, the control system according to the embodiments achieves automatic lockout protection for a viewpoint that not only the control device 11 but also the appliances 13 themselves reduce the security risk. The security system achieves the protection of the appliances 13 from the external attack, for example, by locking out the appliances 13 based on the external network condition. Each appliance 13 is an embedded device like a household electric appliance, and has processing capacity and cost constraints. The security system is therefore configured to achieve the protection function with light operation.

There are various methods for achieving the protection function like this. For example, this protection function may be installed in each appliance 13 in advance, or may be implemented by a sensor attached to each appliance 13 afterward. Otherwise, this protection function may be installed in the control device 11 in advance, or may be implemented by updating the program of the control device 11 afterward.

The lockout is a function of temporarily suspending all the activated network services and enabling the unlocking means. In other words, the lockout is a function of disconnecting communications by use of software. Meanwhile, the unlocking is performed by manipulating a switch. This switch includes various types of switches which the user can physically manipulate. The unlocking can be performed, for example, by the user's manipulation of physical buttons respectively provided to the appliances 13 and the control device 11. In a case where the appliances 13 and the control device 11 are provided with a screen, the unlocking can be performed by the user's manipulation of the screen.

Receiving of a large amount of transmitted data from the outside, receiving of a large amount of control signals for a short time, having any one appliance 13 stolen, and the like serve as triggers for performing the lockout. Once detecting one of such triggers, the control system enters the appliance 13 into a locked condition in which the appliance 13 temporality suspends its function and rejects all the controls to be carried out via the network, and then allows only the physical button manipulation to make the appliance 13 return to the normal condition. Thereby, the control system provides the protection function of minimizing the damage on the appliance 13 to be caused by the external attack.

### Embodiment 1

The above-discussed protection function (hereinafter referred to as a “protection function”) may be provided to both the control device 11 and the appliances 13, or either the control device 11 or the appliances 13. Embodiment 1 will describe a case where the control device 11 (the device surrounded with a dotted line in FIG. 1) is provided with the protection function while none of the appliances 13 are provided with the protection function.

### [Control Device]

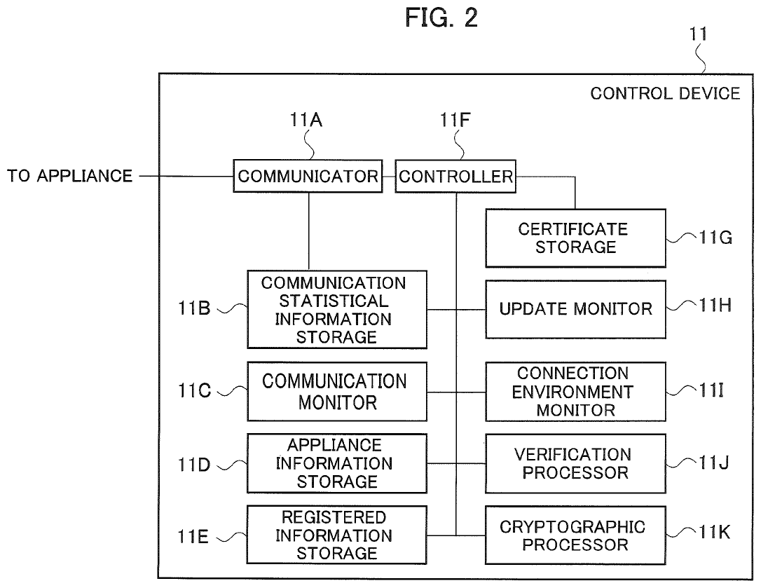

FIG. 2 is a function block diagram of the control device 11 according to Embodiment 1. As illustrated in this drawing, the control device 11 includes a communicator 11A, a communication statistical information storage 11B, a communication monitor 11C, an appliance information storage 11D, a registered information storage 11E, a controller 11F, a certificate storage 11G, an update monitor 11H, a connection environment monitor 11I, a verification processor 11J and a cryptographic processor 11K. The communicator 11A is a functional unit which implements communication I/F with other terminals. The communication statistical information storage 11B is a functional unit which stores statistical information on communications performed by the communicator 11A. The communication monitor 11C is a functional unit which monitors the communications performed by the communicator 11A. The appliance information storage 11D is a functional unit which stores appliance information on the appliances 13 and the like. The registered information storage 11E is a functional unit which stores various pieces of registered information. The controller 11F is a functional unit which performs various controls. The certificate storage 11G is a functional unit which stores a certificate to be used for encrypted communications. The update monitor 11H is a functional unit which monitors actual update results. The connection environment monitor 11I is a functional unit which monitors the connection environment. The verification processor 11J is a functional unit which performs a verification process. The cryptographic processor 11K is a functional unit which performs a cryptographic process.

The control device 11 has a function in which when initially activated, or when registering a new appliance 13 in the control device 11, the control device 11 registers in the server 1 a unique identifier, user information, and IP information for the Internet connection of the appliance 13. When activated, the control device 11 identifies the ISP by retrieving the information registered in the server 1 and acquiring the IP for the Internet connection using the Who-is service and the like, and identifies the ISP by similarly acquiring the current IP, to check whether the two ISPs are identical to each other. If the two ISPs are different from each other, the control device 11 sends the connection configuration change notice to the server 1.

### [Triggers for Performing Lockout]

Descriptions will be hereinbelow provided for triggers for performing the lockout. Detection of an ISP change, detection of an intra-/extra-NW attack, detection of no update for a long time, and the like may be employed as the triggers.

The ISP change means a change in ISP information. A “method in which the ISP information is acquired by inquiring the information of the server 1 and if the ISPs are different from each other, the user's smartphone 2 is informed of the difference” may be employed as a method of detecting the ISP change. The “difference from the ISP information stored in initial registration” may be employed as a criterion for detecting the ISP change.

The intra-/extra-NW attack means an attack from inside or outside the house. Descriptions will be later provided for a method of detecting the intra-/extra-NW attack. “Abnormal control (control signal intervals (ON/OFF))” and a “DoS attack from an unregistered IP (mass packet transmission)” may be employed as objects of the intra-/extra-NW attack detection.

The “no update for a long time” means that the software has not been updated for a predetermined length or longer. A “method in which it is checked whether access to an update server and a resultant update are performed periodically (once a day)” may be employed as a method of detecting no update for a long time. An “update check for a certain period (for example, one year or the like)” may be employed as a criterion for detecting no update for a long time.

### [Intra-/Extra-NW Attack]

Detailed descriptions will be hereinbelow provided for the intra-/extra-NW attack.

The “switching of the ON/OFF control at short intervals” may be employed as an object (criterion) of the intra-/extra-NW attack detection. For example, two or more ON/OFF switchings per second may be determined as an intra-/extra-NW attack.

The “transmitting of an ON or OFF control signal for a long time” may be employed as another object (criterion) of the intra-/extra-NW attack detection. For example, the ON or OFF control signal continuously received for 30 minutes or more may be determined as another intra-/extra-NW attack.

It is preferable that a defensive action against the detected intra-/extra-NW attack be performed stepwise, such as by shifting a warning action to a filtering action, and an appliance locking action. This is because a sudden appliance locking (a sudden locking of the control device 11) may cause a feeling of inconvenience depending on situations.

The warning action is to send the transmission source a warning that the ON/OFF control is switched at too short intervals to respond to the ON/OFF control if a warning criterion is satisfied. “Signals received twice or more per second and continuously eight times or more” may be employed as the warning criterion.

The filtering action is to filter all the control communications from a specific transmission source for a certain period in a case where the attack continues even after the warning is sent. “Signals received twice or more per second and continuously 20 times or more” may be employed as the filtering criterion.

The appliance locking action is to shift to a locking condition by cutting off all the communications for the purpose of keeping the appliances safe in a case where the attack continues for a certain period despite the filtering, or in a case where attacks come from multiple transmission sources for the certain period. “Signals received twice or more per second and continuously for 30 minutes or more” may be employed as the appliance locking criterion.

### [Sequence]

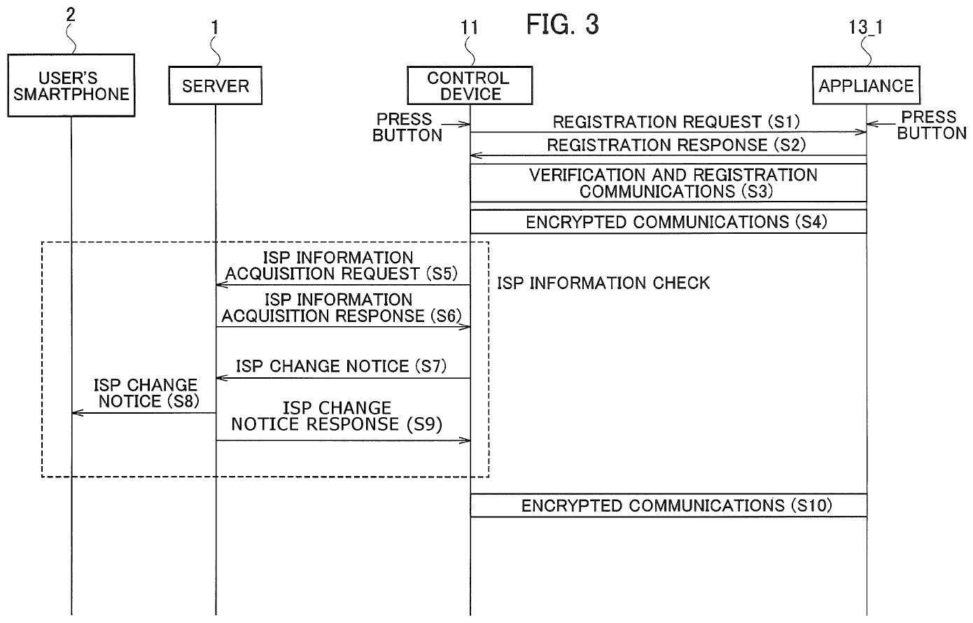

FIG. 3 is a sequence diagram of the control system according to Embodiment 1. In this section, assuming that the ISP information is changed, descriptions will be provided for a procedure for detecting the ISP change.

To begin with, in order to register the new appliance 13_1 in the control device 11, the user presses the button on the control device 11 and the button on the appliance 13_1. Thereby, a registration request is sent from the control device 11 to the appliance 13_1 (S1), and a registration response is sent from the appliance 13_1 to the control device 11 (S2). Thereby, verification and registration communications are performed between the control device 11 and the appliance 13_1 (S3), and encrypted communications can be performed between the control device 11 and the appliance 13_1 (S4).

When activated, the connection environment monitor 11I of the control device 11 checks the ISP information. Specifically, the connection environment monitor 11I sends an ISP information acquisition request to the server 1 (S5), and receives an ISP information acquisition response from the server 1 (S6). If the result is that the acquired ISP information is different from the ISP information stored in the initial registration, the connection environment monitor 11I sends an ISP change notice to the server 1 (S7). In this case, the server 1 transfers the ISP change notice to the user's smartphone 2 (S8), and sends an ISP change notice response to the control device 11 (S9). Thereby, encrypted communications can be performed between the control device 11 and the appliance 13_1 (S10).

As discussed above, the control system according to Embodiment 1 causes the ISP change notice to be sent to the user's smartphone 2 in the case where the network connection environment is changed. Accordingly, in a case where the appliance 13_1 is stolen from the A household 10 and is set up in the B household 20, the ISP change notice is sent to the user's smartphone 2 owned by the user living in the A household 10. Using the ISP change notice as a clue, the user living in the A household 10 can promptly deals with the theft. For example, the user can erase the data in the appliance 13_1 by sending an erase signal to the appliance 13_1.

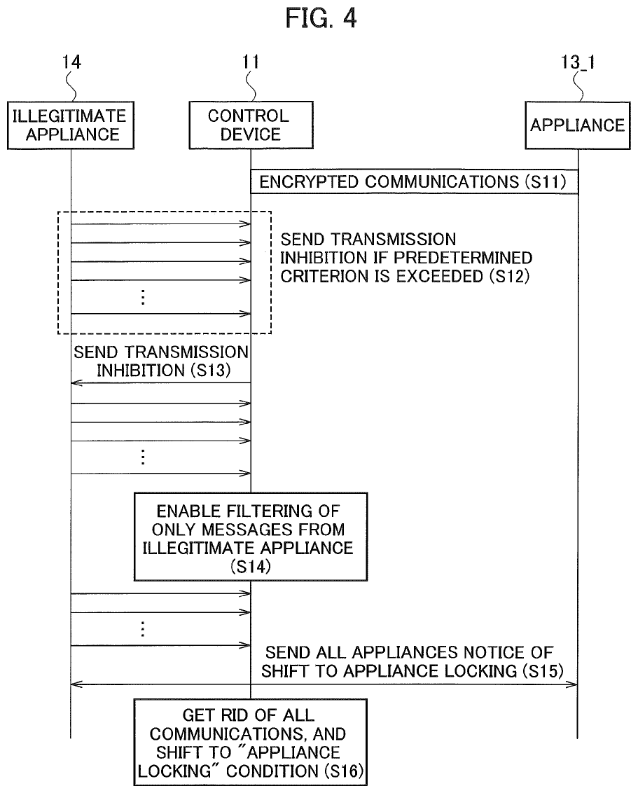

FIG. 4 is another sequence diagram of the control system according to Embodiment 1. In this section, assuming that a DoS attack on the control device 11 from inside the house occurs, descriptions will be provided for how to detect the DoS attack on the control device 11 and a procedure for dealing with the DoS attack thereon.

To begin with, the encrypted communications are being performed between the control device 11 and the appliance 13_1 (S11). In this situation, let us assume that the illegitimate appliance 14 introduced into the house starts the DoS attack on the control device 11.

If a signal received from the illegitimate appliance 14 exceed a predetermined criterion, the communication monitor 11C of the control device 11 determines that there is a sign of the DoS attack, and, first of all, sends transmission inhibition to the illegitimate appliance 14 (S12→S13). If the sign of the DoS attack continues despite the sending of the transmission inhibition, the control device 11 enables the filtering of only the messages from the illegitimate appliance 14 (S14). If the sign of the DoS attack continues despite the enabled filtering, the control device 11 sends all the appliances 13 a notice of shift to appliance locking (S15), thereafter gets rid of all the communications, and shifts to the locking condition (S16).

As discussed above, the control system according to Embodiment 1 causes the control device 11 to strengthen its defensive action using its own function on the step-by-step basis in the case where the DoS attack on the control device 11 from inside the house occurs. Thereby, the control system is capable of automatically protecting the control device 11 from the attack from inside the house while securing the convenience. Furthermore, since the control system causes the control device 11 to send all the appliances 13 the notice of the shift to the appliance locking before the control device 11 becomes locked out, the control system is capable of minimizing the influence of the lockout on communications to all the appliances 13.

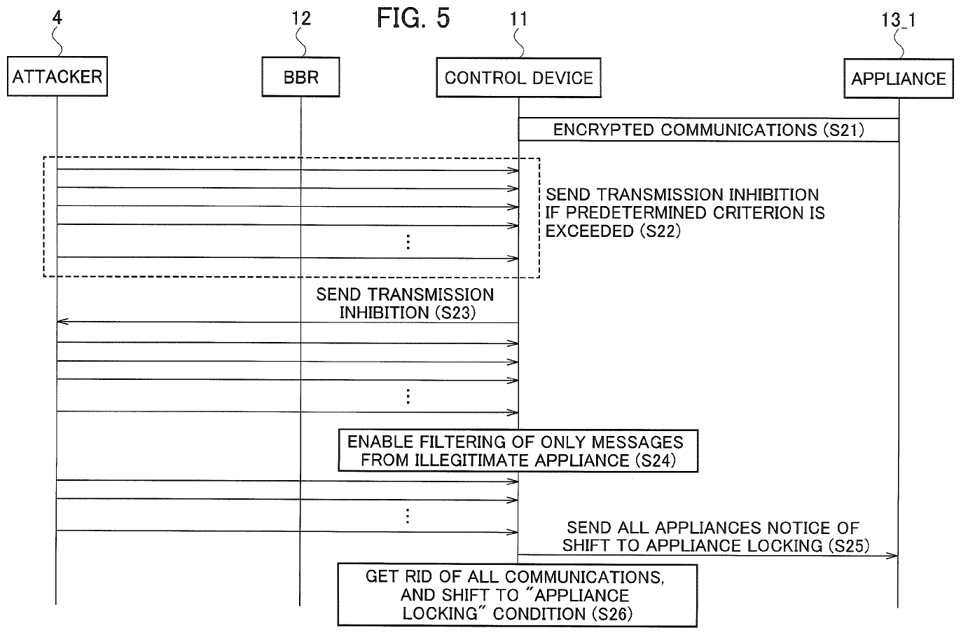

FIG. 5 is yet another sequence diagram of the control system according to Embodiment 1. In this section, assuming that a DoS attack on the control device 11 from outside the house occurs, descriptions will be provided for how to detect the DoS attack on the control device 11 and a procedure for dealing with the DoS attack thereon.

To begin with, the encrypted communications are being performed between the control device 11 and the appliance 13_1 (S21). In this situation, let us assume that the attacker 4 outside the house starts the DoS attack on the control device 11.

If a signal received from the attacker 4 exceed the predetermined criterion, the communication monitor 11C of the control device 11 determines that there is a sign of the DoS attack, and, first of all, sends transmission inhibition to the attacker 4 (S22→S23). If the sign of the DoS attack continues despite the sending of the transmission inhibition, the control device 11 enables the filtering of only the messages from the attacker 4 (S24). If the sign of the DoS attack continues despite the enabled filtering, the control device 11 sends all the appliances 13 a notice of shift to appliance locking (S25), and thereafter gets rid of all the communications to shift to the locking condition (S26).

As discussed above, the control system according to Embodiment 1 causes the control device 11 to strengthen its defensive action using its own function on the step-by-step basis in the case where the DoS attack on the control device 11 from outside the house occurs. Thereby, the control system is capable of automatically protecting the control device 11 from the attack from outside the house while securing the convenience. Furthermore, since the control system causes the control device 11 to send all the appliances 13 the notice of the shift to the appliance locking before the control device 11 becomes locked out, the control system is capable of minimizing the influence of the lockout on communications to all the appliances 13.

### [Check on DoS Attack Communication]

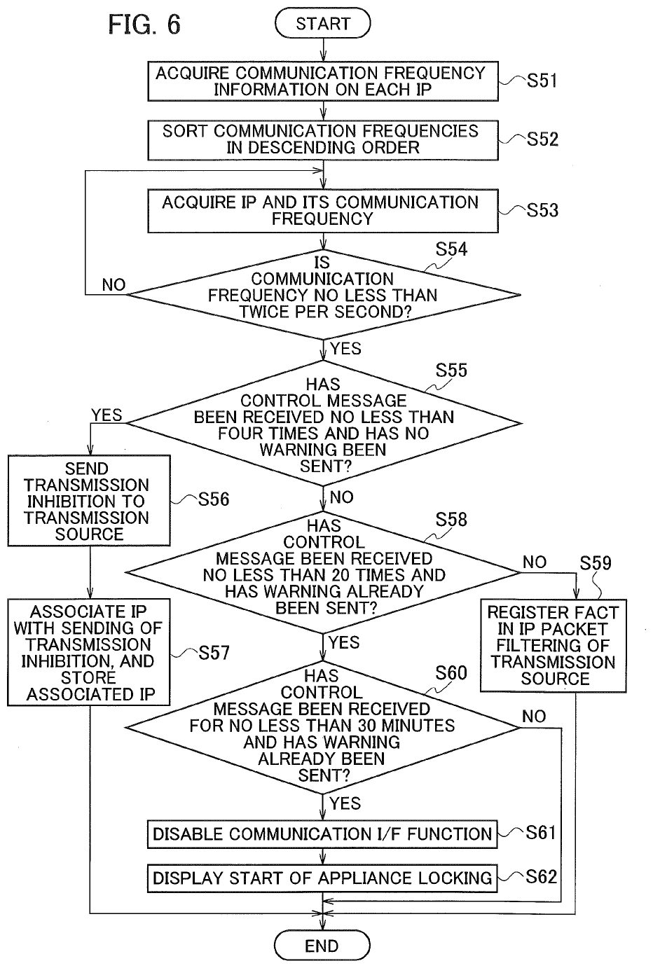

FIG. 6 is a flowchart illustrating how the control system works to check DoS attack communication. The implementer of the flowchart is the communication monitor 11C of the control device 11.

To begin with, the communication monitor 11C acquires each IP's information on its communication frequency (S51), and sorts the acquired communication frequencies in descending order (S52). The communication monitor 11C acquires the highest-ranked IP and its communication frequency (S53), and determines whether the communication frequency is no less than twice per second (S54).

If the communication frequency is no less than twice per second (S54: YES), the communication monitor 11C determines whether the communication monitor 11C has received the control message no less than four times and has not sent the warning yet (S55). On the other hand, if the communication frequency is not twice or more per second (S54: NO), the communication monitor 11C acquires the second highest-ranked IP and its communication frequency (S53), and repeats the same process.

If the communication monitor 11C has received the control message no less than four times and has not sent the warning yet (S55: YES), the communication monitor 11C sends the transmission inhibition to the transmission source (S56), associates the IP with the sending of the transmission inhibition to store the associated IP (S57), and terminates the flowchart. On the other hand, if the communication monitor 11C has received the control message no less than four times and has already sent the warning (S55: NO), the communication monitor 11C determines whether the communication monitor 11C has received the control message no less than 20 times and has already sent the warning (S58).

If the communication monitor 11C has received the control message no less than 20 times and has already sent the warning (S58: NO), the communication monitor 11C registers the fact in the packet filtering of the transmission source IP (S59), and terminates the flowchart. On the other hand, if the communication monitor 11C has received the control message no less than 20 times and has not sent the warning yet (S58: YES), the communication monitor 11C whether the communication monitor 11C has received the control message for no less than 30 minutes and has already sent the warning (S60).

If the communication monitor 11C has received the control message for no less than 30 minutes and has already sent the warning (S60: YES), the communication monitor 11C disables the communication I/F function (S61), and displays the start of the appliance locking (S62), thereafter terminating the flowchart. In a case where the appliances are provided with no screen, the communication monitor 11C may use a voice message about the start of the appliance locking.

As discussed above, the communication monitor 11C always monitors the communications and detects a communication which agrees with the predetermined condition. If the communication monitor 11C detects the communication which agrees with the predetermined condition, the communication monitor 11C informs the user of the detection, and performs the appliance locking.

It should be noted that the communication statistical information storage 11B always monitors the communications. The communication monitor 11C acquires a communication with the highest communication frequency from the communication statistical information storage 11B. The communication monitor 11C determines whether the thus-acquired frequency satisfies the predetermined condition, and detects the communication if the frequency satisfies the predetermined condition.

### [Check on Update Implementation Status]

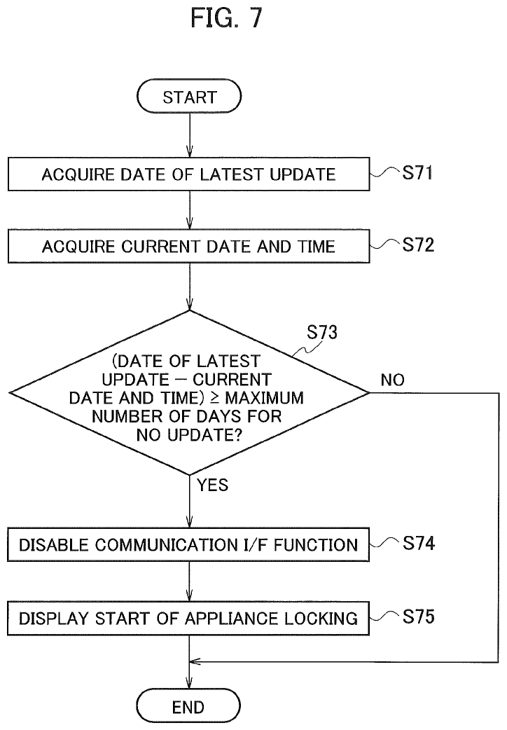

FIG. 7 is a flowchart illustrating how the control system works to check the update implementation status. The implementer of the flowchart is the update monitor 11H of the control device 11.

To begin with, the update monitor 11H acquires the date of the latest update (S71), acquires the current date and time (S72), and determines whether “(the date of the latest update−the current date and time)≥a maximum number of days for no update” (S73). The maximum number of days for no update is a maximum number of days for which the update is allowed not to be performed, such as 180 days.

If “(the date of the latest update−the current date and time)≥the maximum number of days for no update” is not satisfied (S73: NO), the update monitor 11H terminates the flowchart. On the other hand, if “(the date of the latest update−the current date and time)≥the maximum number of days for no update” is satisfied (S73: YES), the update monitor 11H disables the communication I/F function (S74), and displays the start of the appliance locking (S75), thereafter terminating the flowchart. In a case where the appliances are provided with no screen, the update monitor 11H may use a voice message about the start of the appliance locking.

As discussed above, the update monitor 11H checks whether the update has been performed, for example once a day, and thereby examines whether (the date of the latest update−the current date and time) exceeds the “maximum number of days for no update” which is set in advance before shipment from the factory. If (the date of the latest update−the current date and time) exceeds the “maximum number of days for no update,” the update monitor 11H promptly performs the “appliance locking” and thereby cuts off the communications with the outside.

### [Check on ISP Change]

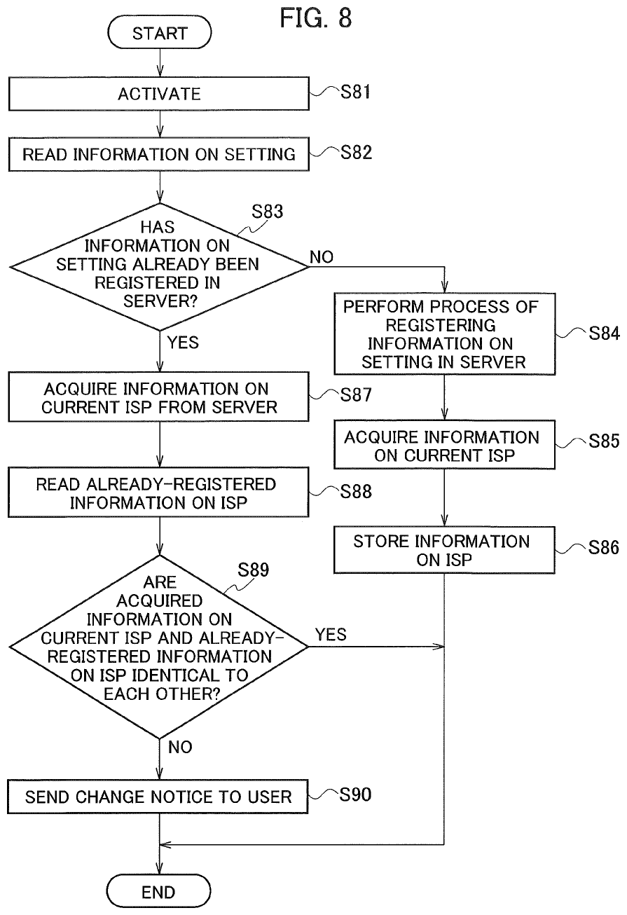

FIG. 8 is a flowchart illustrating how the control system works to check the ISP change. The implementer of the flowchart is the connection environment monitor 11I of the control device 11.

To begin with, once activated, the connection environment monitor 11I reads setting information (S81→S82), and determines whether the setting information has already been registered in the server 1 (S83). The setting information is the registered information stored in the registered information storage 11E.

If the setting information has not been registered in the server 1 yet (S83: NO), the connection environment monitor 11I performs a process of registering the setting information in the server 1 (S84), acquires current ISP information (S85), stores the acquired ISP information in the registered information storage 11E (S86), and terminates the flowchart. On the other hand, if the setting information has already been registered in the server 1 (S83: YES), the connection environment monitor 11I acquires the current ISP information from the server 1 (S87), reads the ISP information which has already been stored in the registered information storage 11E (S88), and determines whether the acquired current ISP information and the ISP information having been stored in the registered information storage 11E are identical to each other (S89).

If the acquired current ISP information and the ISP information having been stored in the registered information storage 11E are identical to each other (S89: YES), the connection environment monitor 11I terminates the flowchart. On the other hand, if the acquired current ISP information and the ISP information having been stored in the registered information storage 11E are not identical to each other (S89: NO), the connection environment monitor 11I sends the change notice (S90) to the user, and terminates the flowchart.

As discussed above, once activated, the connection environment monitor 11I checks whether the current ISP is identical to the ISP used in the previous connection. If the current ISP is different from the ISP used in the previous connection, the connection environment monitor 11I informs the user of the difference.

As discussed above, in the control system according to Embodiment 1, the appliances 13 and the user's smartphone 2 assigned to control the appliances 13 are stored in the server 1 in association with each other. The control device 11 is connected to the server 1 via the network 3, and upon receipt of an instruction from the user's smartphone 2, controls the operating conditions of the respective appliances 13. In the control system like this, the control device 11 determines whether the signal received from a different terminal satisfies the predetermined criterion, and cuts off all the communications via the network if the control device 11 determines that the signal satisfies the predetermined criterion. Thereby, the locking condition is established once the control device 11 detects the sign of malfunction, failure or the like. Accordingly, the security risk can be reduced.

Furthermore, the configuration may be such that: if the signal received from the different terminal is a control signal which instructs ON or OFF more frequently than a predetermined frequency, the control device 11 determines that the predetermined criterion is satisfied. Thereby, the locking condition is established once the control device 11 detects the abnormal control signal from the network. Accordingly, the control device 11 is capable of protecting itself from malfunction to be caused by such a control signal.

In addition, the configuration may be such that: the server 1 stores the ISP information of the control device 11; each time activated, the control device 11 acquires the ISP information; and if the acquired ISP information is different from the ISP information stored in the server 1, the control device 11 determines that the predetermined criterion is satisfied. Thereby, the locking condition is established when the control device 11 is put into a network environment different from that in which the control device 11 is set up for the first time. This makes it possible to prevent the theft and use of the control device 11, as well as the abuse of the control device 11.

Moreover, the configuration may be such that: the control device 11 periodically inspects its own update check status; and if no check has been performed for a predetermined period, or if no update has been performed for the predetermined period, the control device 11 determines that the predetermined criterion is satisfied. Thereby, the locking condition is established in the case where the update is not managed. Accordingly, it is possible to prevent a malware attack on the control device 11 from the outside which would otherwise occur because the security has not been updated and the control device 11 remains vulnerable.

Besides, the configuration may be such that: the control device 11 has a switch; and when the switch is manipulated, the control device 11 recovers communications via the network. This makes it possible to recover the control device 11 in response to the user's physical manipulation, and to secure the safety.

Furthermore, the configuration may be such that: if the number of times the control device 11 cuts off all the communications via the network is equal to or less than a predetermined number (n), the control device 11 automatically recovers communications after a predetermined time elapses; and if the number of times the control device 11 cuts off all the communications via the network exceeds the predetermined number (becomes equal to n+1), the control device 11 recovers communications only when the switch is manipulated. This makes it possible to automatically recover communications from the temporary abnormality without the user's manipulation, and to reduce the user's work for the recovery while maintaining the safety.

Moreover, the configuration may be such that if the control device 11 determines that a signal received from a terminal which is not stored in the server 1 in association with the appliances 13 satisfies the predetermined criterion, the control device 11 cuts off all the communications via the network. In other words, even in the case where the control device 11 detects a sign of malfunction, failure or the like, communications can be performed as usual between the control device 11 and the terminals registered in the server 1.

### Embodiment 2

Embodiment 2 will describe a case in which the appliances 13_1 to 13_4 are each provided with the protection function while the control device 11 is provided with no protection function. The following descriptions will be provided mainly for what makes Embodiment 2 different from Embodiment 1.

### [Household Appliances]

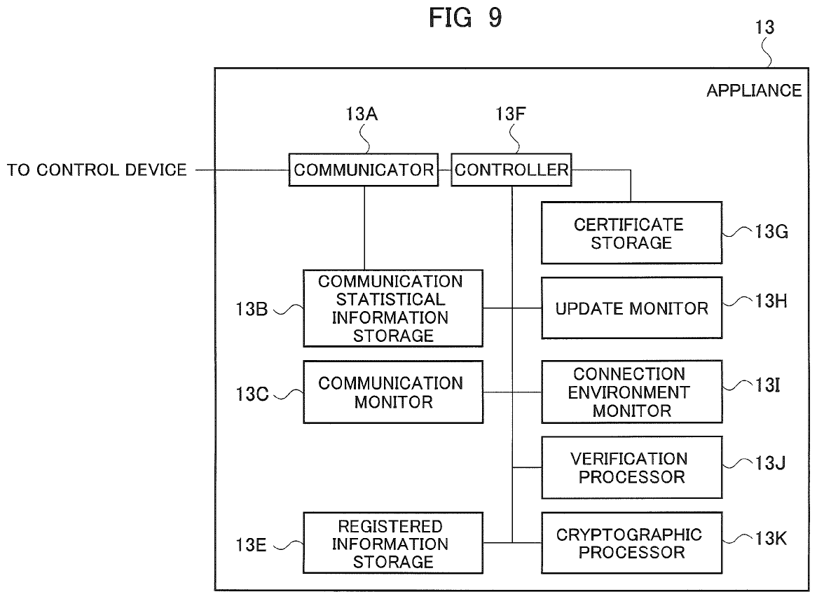

FIG. 9 is a function block diagram common to the appliances 13 according to Embodiment 2. As illustrated in the drawing, each appliance 13 includes a communicator 13A, a communication statistical information storage 13B, a communication monitor 13C, a registered information storage 13E, a controller 13F, a certificate storage 13G, an update monitor 13H, a connection environment monitor 13I, a verification processor 13J and a cryptographic processor 13K. The communicator 13A is a functional unit which implements communication I/F with other terminals. The communication statistical information storage 13B is a functional unit which stores statistical information on communications performed by the communicator 13A. The communication monitor 13C is a functional unit which monitors the communications performed by the communicator 13A. The registered information storage 13E is a functional unit which stores various pieces of registered information. The controller 13F is a functional unit which performs various controls. The certificate storage 13G is a functional unit which stores a certificate to be used for encrypted communications. The update monitor 13H is a functional unit which monitors actual update results. The connection environment monitor 13I is a functional unit which monitors the connection environment. The verification processor 13J is a functional unit which performs a verification process. The cryptographic processor 13K is a functional unit which performs a cryptographic process.

As already discussed, the appliances 13 are the air conditioner, the washing machine, the electric light, the hot water dispenser and the like. The original functions of the appliances 13 are different from one another, and are implemented by their respective controllers 13F.

### [Sequence]

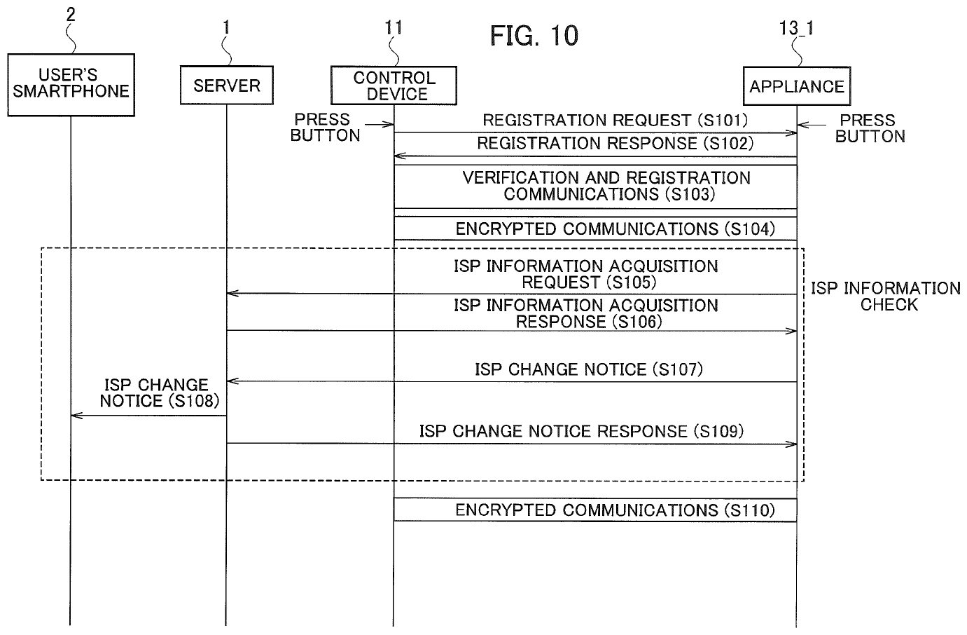

FIG. 10 is a sequence diagram of the control system according to Embodiment 2. In this section, assuming that the ISP information is changed, descriptions will be provided for a procedure for detecting the ISP change.

To begin with, in order to register the new appliance 13_1 in the control device 11, the user presses the button on the control device 11 and the button on the appliance 13_1. Thereby, a registration request is sent from the control device 11 to the appliance 13_1 (S101), and a registration response is sent from the appliance 13_1 to the control device 11 (S102). Thereby, verification and registration communications are performed between the control device 11 and the appliance 13_1 (S103), and encrypted communications can be performed between the control device 11 and the appliance 13_1 (S104).

When activated, the connection environment monitor 13I of the appliance 13_1 checks the ISP information. Specifically, the connection environment monitor 13I sends an ISP information acquisition request to the server 1 (S105), and receives an ISP information acquisition response from the server 1 (S106). If the result is that the acquired ISP information is different from the ISP information stored in the initial registration, the connection environment monitor 13I sends an ISP change notice to the server 1 (S107). In this case, the server 1 transfers the ISP change notice to the user's smartphone 2 (S108), and sends an ISP change notice response to the appliance 13_1 (S109). Thereby, encrypted communications can be performed between the control device 11 and the appliance 13_1 (S110).

As discussed above, the control system according to Embodiment 2 causes the ISP change notice to be sent to the user's smartphone 2 in the case where the network connection environment is changed. Accordingly, in a case where the control device 11 is stolen from the A household 10 and is set up in the B household 20 (see FIG. 1), the ISP change notice is sent to the user's smartphone 2 owned by the user living in the A household 10. Using the ISP change notice as a clue, the user living in the A household 10 can promptly deals with the theft. For example, the user can erase the data in the control device 11 by sending an erase signal to the control device 11.

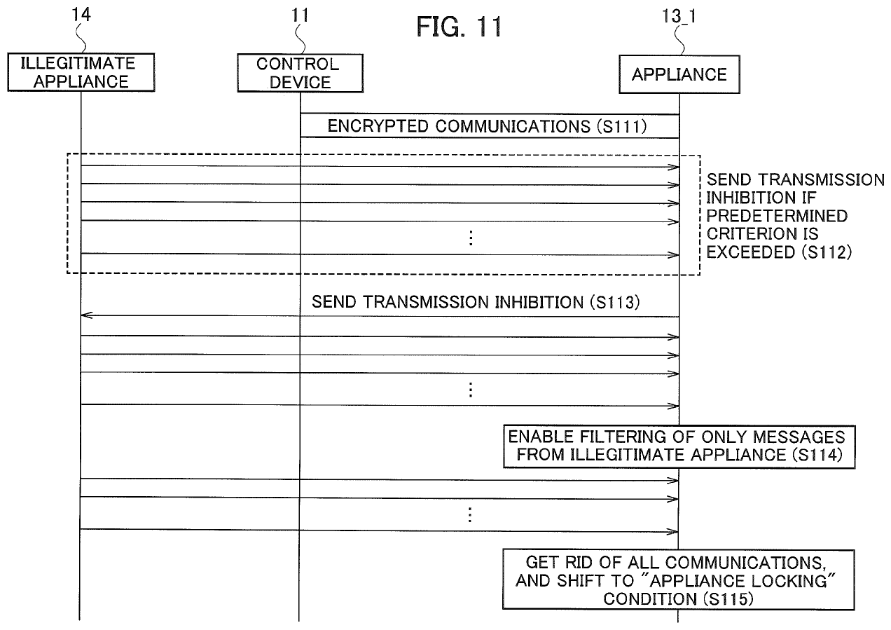

FIG. 11 is another sequence diagram of the control system according to Embodiment 2. In this section, assuming that a DoS attack on the appliance 13_1 from inside the house occurs, descriptions will be provided for how to detect the DoS attack on the appliance 13_1 and a procedure for dealing with the DoS attack thereon.

To begin with, the encrypted communications are being performed between the control device 11 and the appliance 13_1 (S111). In this situation, let us assume that the illegitimate appliance (malware-infecting appliance) 14 introduced into the house starts the DoS attack on the appliance 13_1.

If a signal received from the illegitimate appliance 14 exceed a predetermined criterion, the communication monitor 13C of the appliance 13_1 determines that there is a sign of the DoS attack, and, first of all, sends transmission inhibition to the illegitimate appliance 14 (S112→S113). If the sign of the DoS attack continues despite the sending of the transmission inhibition, the communication monitor 13C enables the filtering of only the messages from the illegitimate appliance 14 (S114). If the sign of the DoS attack continues despite the enabled filtering, the communication monitor 13C gets rid of all the communications, and shifts to the locking condition (S115).

As discussed above, the control system according to Embodiment 2 causes the appliance 13_1 to strengthen its defensive action using its own function on the step-by-step basis in the case where the DoS attack on the appliance 13_1 from inside the house occurs. Thereby, the control system is capable of automatically protecting the appliance 13_1 from the attack from inside the house while securing the convenience.

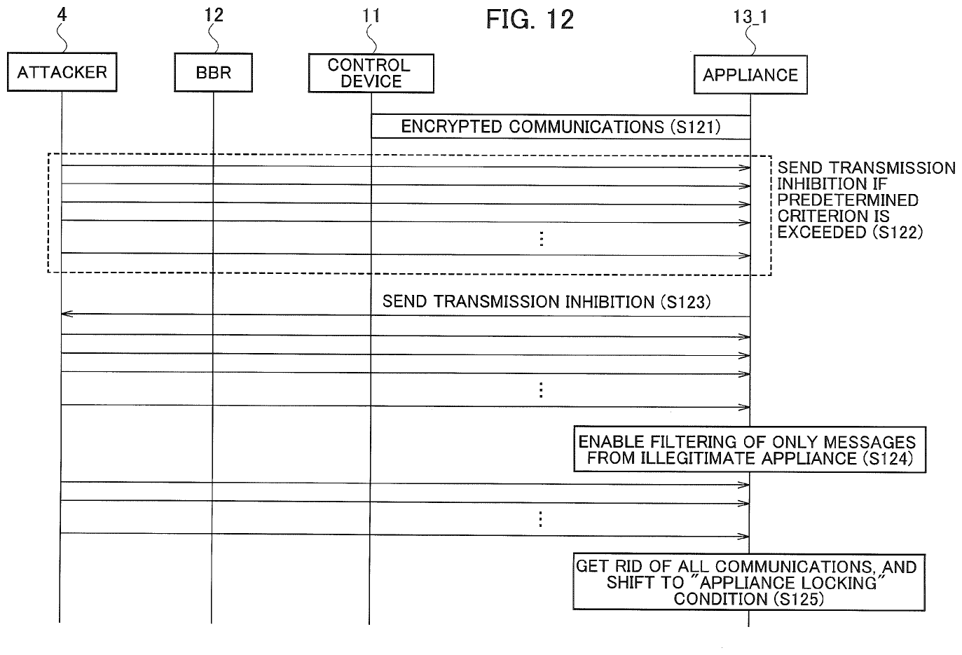

FIG. 12 is yet another sequence diagram of the control system according to Embodiment 2. In this section, assuming that a DoS attack on the appliance 13_1 from outside the house occurs, descriptions will be provided for how to detect the DoS attack on the appliance 13_1 and a procedure for dealing with the DoS attack thereon.

To begin with, the encrypted communications are being performed between the control device 11 and the appliance 13_1 (S121). In this situation, let us assume that the attacker 4 (see FIG. 1) outside the house starts the DoS attack on the appliance 13_1.

If a signal received from the attacker 4 exceed the predetermined criterion, the communication monitor 13C of the appliance 13_1 determines that there is a sign of the DoS attack, and, first of all, sends transmission inhibition to the attacker 4 (S122→S123). If the sign of the DoS attack continues despite the sending of the transmission inhibition, the communication monitor 13C enables the filtering of only the messages from the attacker 4 (S124). If the sign of the DoS attack continues despite the enabled filtering, the communication monitor 13C gets rid of all the communications to shift to the locking condition (S125).

As discussed above, the control system according to Embodiment 2 causes the appliance 13_1 to strengthen its defensive action using its own function on the step-by-step basis in the case where the DoS attack on the appliance 13_1 from outside the house occurs. Thereby, the control system is capable of automatically protecting the appliance 13_1 from the attack from outside the house while securing the convenience.

### [Check on DoS Attack Communication]

Embodiment 2 also uses the flowchart in FIG. 6 to describe how the control system works to check DoS attack communication. The implementer of the flowchart is the communication monitor 13C of the appliance 13.

To begin with, the communication monitor 13C acquires each IP's information on its communication frequency (S51), and sorts the acquired communication frequencies in descending order (S52). The communication monitor 13C acquires the highest-ranked IP and its communication frequency (S53), and determines whether the communication frequency is no less than twice per second (S54).

If the communication frequency is no less than twice per second (S54: YES), the communication monitor 13C determines whether the communication monitor 13C has received the control message no less than four times and has not sent the warning yet (S55). On the other hand, if the communication frequency is not twice or more per second (S54: NO), the communication monitor 13C acquires the second highest-ranked IP and its communication frequency (S53), and repeats the same process.

If the communication monitor 13C has received the control message no less than four times and has not sent the warning yet (S55: YES), the communication monitor 13C sends the transmission inhibition to the transmission source (S56), and associates the IP with the sending of the transmission inhibition to store the associated IP (S57), thereafter terminating the flowchart. On the other hand, if the communication monitor 13C has received the control message no less than four times and has already sent the warning (S55: NO), the communication monitor 13C determines whether the communication monitor 13C has received the control message no less than 20 times and has already sent the warning (S58).

If the communication monitor 13C has received the control message no less than 20 times and has already sent the warning (S58: NO), the communication monitor 13C registers the fact in the packet filtering of the transmission source IP (S59), and terminates the flowchart. On the other hand, if the communication monitor 13C has received the control message no less than 20 times and has not sent the warning yet (S58: YES), the communication monitor 13C whether the communication monitor 13C has received the control message for no less than 30 minutes and has already sent the warning (S60).

If the communication monitor 13C has received the control message for no less than 30 minutes and has already sent the warning (S60: YES), the communication monitor 13C disables the communication I/F function (S61), and displays the start of the appliance locking (S62), thereafter terminating the flowchart. In a case where no screen is provided, the communication monitor 13C may use a voice message about the start of the appliance locking.

As discussed above, the communication monitor 13C always monitors the communications and detects a communication which agrees with the predetermined condition. If the communication monitor 13C detects the communication which agrees with the predetermined condition, the communication monitor 13C informs the user of the detection, and performs the appliance locking.

It should be noted that the communication statistical information storage 13B always monitors the communications. The communication monitor 13C acquires a communication with the highest communication frequency from the communication statistical information storage 13B. The communication monitor 13C determines whether the thus-acquired frequency satisfies the predetermined condition, and detects the communication if the frequency satisfies the predetermined condition.

### [Check on Update Implementation Status]

Embodiment 2 also uses the flowchart in FIG. 7 to describe how the control system works to check the update implementation status. The implementer of the flowchart is the update monitor 13H of the appliance 13.

To begin with, the update monitor 13H acquires the date of the latest update (S71), acquires the current date and time (S72), and determines whether “(the date of the latest update−the current date and time)≥a maximum number of days for no update” (S73). The maximum number of days for no update is a maximum number of days for which the update is allowed not to be performed, such as 180 days.

If “(the date of the latest update−the current date and time)≥the maximum number of days for no update” is not satisfied (S73: NO), the update monitor 13H terminates the flowchart. On the other hand, if “(the date of the latest update−the current date and time)≥the maximum number of days for no update” is satisfied (S73: YES), the update monitor 13H disables the communication I/F function (S74), and displays the start of the appliance locking (S75), thereafter terminating the flowchart. In a case where no screen is provided, the update monitor 13H may use a voice message about the start of the appliance locking.

As discussed above, the update monitor 13H checks whether the update has been performed, for example once a day, and thereby examines whether (the date of the latest update−the current date and time) exceeds the “maximum number of days for no update” which is set in advance before shipment from the factory. If (the date of the latest update−the current date and time) exceeds the “maximum number of days for no update,” the update monitor 13H promptly performs the “appliance locking” and thereby cuts off the communications with the outside.

### [Check on ISP Change]

Embodiment 2 also uses the flow chart in FIG. 8 to describe how the control system works to check the ISP change. The implementer of the flowchart is the connection environment monitor 13I of the appliance 13.

To begin with, once activated, the connection environment monitor 13I reads setting information (S81→S82), and determines whether the setting information has already been registered in the server 1 (S83). The setting information is the registered information stored in the registered information storage 13E.

If the setting information has not been registered in the server 1 yet (S83: NO), the connection environment monitor 13I performs a process of registering the setting information in the server 1 (S84), acquires current ISP information (S85), stores the acquired ISP information in the registered information storage 13E (S86), and terminates the flowchart. On the other hand, if the setting information has already been registered in the server 1 (S83: YES), the connection environment monitor 13I acquires the current ISP information from the server 1 (S87), reads the ISP information which has already been stored in the registered information storage 13E (S88), and determines whether the acquired current ISP information and the ISP information having been stored in the registered information storage 13E are identical to each other (S89).

If the acquired current ISP information and the ISP information having been stored in the registered information storage 13E are identical to each other (S89: YES), the connection environment monitor 13I terminates the flowchart. On the other hand, if the acquired current ISP information and the ISP information having been stored in the registered information storage 13E are not identical to each other (S89: NO), the connection environment monitor 13I sends the change notice (S90) to the user, and terminates the flowchart.

As discussed above, once activated, the connection environment monitor 13I checks whether the current ISP is identical to the ISP used in the previous connection. If the current ISP is different from the ISP used in the previous connection, the connection environment monitor 13I informs the user of the difference.

As discussed above, in the control system according to Embodiment 2, the appliances 13 and the user's smartphone 2 assigned to control the appliances 13 are stored in the server 1 in association with each other. The control device 11 is connected to the server 1 via the network 3, and upon receipt of an instruction from the user's smartphone 2, controls the operating conditions of the respective appliances 13. In the control system like this, each appliance 13 determines whether the signal received from a different terminal satisfies the predetermined criterion, and cuts off all the communications via the network if the appliance 13 determines that the signal satisfies the predetermined criterion. Thereby, the locking condition is established once the appliance 13 detects the sign of malfunction, failure or the like. Accordingly, the security risk can be reduced.

Furthermore, the configuration may be such that: if the signal received from the different terminal is a control signal which instructs ON or OFF more frequently than a predetermined frequency, the appliance 13 determines that the predetermined criterion is satisfied. Thereby, the locking condition is established once the appliance 13 detects the abnormal control signal from the network. Accordingly, the appliance 13 is capable of protecting itself from malfunction to be caused by such a control signal.

In addition, the configuration may be such that: the server 1 stores the ISP information of the appliance 13; each time activated, the appliance 13 acquires the ISP information; and if the acquired ISP information is different from the ISP information stored in the server 1, the appliance 13 determines that the predetermined criterion is satisfied. Thereby, the locking condition is established when the appliance 13 is put into a network environment different from that in which the appliance 13 is set up for the first time. This makes it possible to prevent the theft and use of the appliance 13, as well as the abuse of the appliance 13.

Moreover, the configuration may be such that: the appliance 13 periodically inspects its own update check status; and if no check has been performed for the predetermined period, or if no update has been performed for the predetermined period, the appliance 13 determines that the predetermined criterion is satisfied. Thereby, the locking condition is established in the case where the update is not managed. Accordingly, it is possible to prevent a malware attack on the appliance 13 from the outside which would otherwise occur because the security has not been updated and the appliance 13 remains vulnerable.

Besides, the configuration may be such that: the appliance 13 has a switch; and when the switch is manipulated, the appliance 13 recovers communications via the network. This makes it possible to recover the appliance 13 in response to the user's physical manipulation, and to secure the safety.

Furthermore, the configuration may be such that: if the number of times the appliance 13 cuts off all the communications via the network is equal to or less than the predetermined number (n), the appliance 13 automatically recovers communications after the predetermined time elapses; and if the number of times the appliance 13 cuts off all the communications via the network exceeds the predetermined number (becomes equal to n+1), the appliance 13 recovers communications only when the switch is manipulated. This makes it possible to automatically recover communications from the temporary abnormality without the user's manipulation, and to reduce the user's work for the recovery while maintaining the safety.

Moreover, the configuration may be such that if the appliance 13 determines that a signal received from a terminal which is not stored in the server 1 in association with the appliance 13 satisfies the predetermined criterion, the appliance 13 cuts off all the communications via the network. In other words, even in the case where the appliance 13 detects a sign of malfunction, failure or the like, communications can be performed as usual between the appliance 13 and the terminals registered in the server 1.

It should be noted that when any one of the switches provided to the control device 11 and the appliances 13 is pressed, communications via the network can be recovered. The configuration may be such that: if the number of times all the communications via the network are cut off is equal to or less than the predetermined number (n), communications are automatically recovered after the predetermined time elapses; and if the number of times all the communications via the network are cut off exceeds the predetermined number (becomes equal to n+1), communications are recovered only when the switch is manipulated.

In addition, although the above descriptions have discussed the configuration in which if a signal received from a terminal, such as the attacker 4, which is not registered in the server 1 satisfies the predetermined criterion, the control system shifts to the locking condition, the configuration is not limited to this one. In other words, in a case where a signal received from any one of the terminals registered in the server 1 satisfies the predetermined criterion, too, the control system may shift to the locking condition in order to avoid failure and the like.

Furthermore, although not specifically mentioned in the above descriptions, once the control system shifts to the locking condition, the original functions of the respective appliances 13 may be used while the communications are cut off. For example, the appliance 13_4 may be used as the hot water dispenser when the manipulation panel provided to the appliance 13_4 is manipulated. This makes it possible to employ the original functions of the respective appliances 13 to a maximum extent.

As discussed above, the security monitoring function (protection function) is provided to not only the control device 11 but also each appliance 13. Thereby, even in a case where any appliance 13 is attacked from the outside directly, that is to say, not via the control device 11, the appliance 13 is capable of reducing the security risk on its own. Moreover, since it suffices that the appliance 13 performs a light process of interrupting its communications, the appliance 13 is capable of dealing with the attack without losing its original function even though the appliance 13 is an embedded device like a household electric appliance.

Besides, this security monitoring function can be implemented not only by the control device 11 and the appliances 13, but also as a computer-functioning program in the control device 11 and the appliances 13. It is a matter of course that part of this security monitoring function can be implemented by a cloud server.

The devices (the control device 11 and the appliances 13) according to the present disclosure each include a computer. The computer implements the function of each device according to the present disclosure by executing the program. The computer includes a processor operable by the program as the main part of the hardware configuration. The processor may be of any type as long as the processor is capable of implementing the function by executing the program. The processor includes a semiconductor integrated circuit (IC), or one or multiple electronic circuits including an LSI (large-scale integration). The multiple electronic circuits may be integrated into one chip, or may be provided to multiple chips. The multiple chips may be integrated into a single device, or may be provided to multiple devices. The program is recorded on a non-temporary recording medium, such as a computer-readable ROM, optical disk, or hard disk drive. The program may be stored on the recording medium in advance, or may be supplied to the recording medium via a wide area communication network including the Internet and the like.

### REFERENCE SIGNS LIST

1 server
2 user's smartphone (mobile terminal)
3 network
11 control device
13 appliance (household appliance)

1. A control device in a control system in which the control device connected via a network to a server in which a household appliance and a mobile terminal assigned to control the household appliance are stored in association with each other receives an instruction from the mobile terminal and controls an operating condition of the household appliance, wherein
the control device determines whether a signal received from a different terminal satisfies a predetermined criterion, and
if the control device determines that the signal satisfies the predetermined criterion, the control device cuts off all communications via the network.

2. The control device according to claim 1, wherein if the signal received from the different terminal is a control signal which instructs ON or OFF more frequently than a predetermined frequency, the control device determines that the signal satisfies the predetermined criterion.

3. The control device according to claim 1, wherein
the server stores ISP information of the control device, and
each time activated, the control device acquires ISP information, and determines that the predetermined criterion is satisfied if the acquired ISP information is different from the ISP information stored in the server.

4. The control device according to claim 1, wherein the control device periodically inspects its update check status, and determines that the predetermined criterion is satisfied if no check has been performed for a predetermined period, or if no update has been performed for the predetermined period.

5. The control device according to claim 1, wherein the control device includes a switch, and recovers the communications via the network when the switch is manipulated.

6. The control device according to claim 5, wherein
if the number of times all the communications via the network are cut off is equal to or less than a predetermined number, the control device automatically recovers the communications after a predetermined time elapses, and
if the number of times all the communications via the network are cut off exceeds the predetermined number, the control device recovers the communications only when the switch is manipulated.

7. The control device according to claim 1, wherein if the control device determines that a signal received from a terminal which is not stored in the server in association with the household appliance satisfies the predetermined criterion, the control device cuts off all the communications via the network.

8. A household appliance in a control system in which the control device connected via a network to a server in which a household appliance and a mobile terminal assigned to control the household appliance are stored in association with each other receives an instruction from the mobile terminal and controls an operating condition of the household appliance, wherein
the household appliance determines whether a signal received from a different terminal satisfies a predetermined criterion, and
if the household appliance determines that the signal satisfies the predetermined criterion, the household appliance cuts off all communications via the network.

9. The household appliance according to claim 8, wherein if the signal received from the different terminal is a control signal which instructs ON or OFF more frequently than a predetermined frequency, the household appliance determines that the signal satisfies the predetermined criterion.

10. The household appliance according to claim 8, wherein
the server stores ISP information of the household appliance, and
each time activated, the household appliance acquires the ISP information, and determines that the predetermined criterion is satisfied if the acquired ISP information is different from the ISP information stored in the server.

11. The household appliance according to claim 8, wherein the household appliance periodically inspects its update check status, and determines that the predetermined criterion is satisfied if no check has been performed for a predetermined period, or if no update has been performed for the predetermined period.

12. The household appliance according to claim 8, wherein the household appliance includes a switch, and recovers the communications via the network when the switch is manipulated.

13. The household appliance according to claim 12, wherein
if the number of times all the communications via the network are cut off is equal to or less than a predetermined number, the household appliance automatically recovers the communications after a predetermined time elapses, and
if the number of times all the communications via the network are cut off exceeds the predetermined number, the household appliance recovers the communications only when the switch is manipulated.

14. The household appliance according to claim 8, wherein if the household appliance determines that a signal received from a terminal which is not stored in the server in association with the household appliance satisfies the predetermined criterion, the household appliance cuts off all the communications via the network.

15. A computer-readable storage medium storing a program which causes a computer to function as the control device according to claim 1.

16. A computer-readable storage medium storing a program which causes a computer to function as the household appliance according to claim 1.
